(19) United States
(12) Patent Application Publication
(10) Pub. No.: US 2025/0085453 A1
(43) Pub. Date: Mar. 13, 2025

(54) Resolution In Expected Lithological Zones

(71) Applicant: Halliburton Energy Services, Inc., Houston, TX (US)

(72) Inventor: William David Bethancourt, Houston, TX (US)

(73) Assignee: Halliburton Energy Services, Inc., Houston, TX (US)

(21) Appl. No.: 18/367,297

(22) Filed: Sep. 12, 2023

(51) Int. Cl. G01V 11/00; E21B 47/12; E21B 49/00

(52) U.S. Cl. CPC G01V 11/002; E21B 47/12; E21B 49/00

(57) ABSTRACT

A method which may comprise disposing a bottom hole assembly (BHA) into a wellbore, wherein the BHA comprises a measurement assembly configured to record one or more measurements. The method may further comprise identifying one or more operating depths; forming a telemetry table based at least on one or more operating depths; acquiring a pseudo log by converting one or more measurements into telemetry values with the telemetry table and back to scientific values with the telemetry table; comparing the pseudo log to the one or more measurements to form a comparison; and publishing the telemetry table based at least in part on the comparison.

### BACKGROUND

Wellbores drilled into subterranean formations may enable recovery of desirable fluids (e.g., hydrocarbons) using a number of different techniques. During operation, any number of different bottom hole assemblies may be utilized to recover desirable fluids. Without limitation, logging while drilling (LWD) or measurement while drilling (MWD) methods may implement various downhole tools for gathering downhole measurements. Various downhole tools may comprise directional drilling tools, resistivity tools, density tools, calibration tools, gamma tools, pressure tools, vibration tools, downhole Weight on Bit (WOB)/torque on bit (TOB)/high frequency bending of the drill bit (BOB) data tools, porosity tools. Downhole tools may implement telemetry systems and methods to transmit downhole measurements to the surface.

During drilling, telemetry techniques may incorporate sensors in the wellbore for transmitting downhole measurements to the surface. However, conductive layers within a formation may prevent electromagnetic fields, emitted by telemetry sensors within the production well for communication with the well production system. This requires specific transmission of small electromagnetic fields for electromagnetic waves which may limit extensiveness and resolution of downhole measurements. Thus, preventing an operator from obtaining downhole measurements from downhole tools.

Additionally, telemetry techniques may incorporate mud pulsing for transmitting pressure pulses comprising downhole measurements. Similarly, mud pulsing requires a limited bandwidth. Operators may transmit only a fraction of the possible downhole measurements, utilize low sample rates, or accept resolution limitations. Currently, there is no process for enhancing downhole measurements to increase resolution with limited telemetry bandwidth.

### BRIEF DESCRIPTION OF THE DRAWINGS

These drawings illustrate certain aspects of some examples of the present disclosure and should not be used to limit or define the disclosure.

FIG. 1 illustrates a schematic diagram of a drilling system;

FIG. 2 illustrates an example of an information handling system;

FIG. 3 illustrates an example of a chipset;

FIG. 4 illustrates an example of a cloud based computing network; and

FIG. 5 illustrates telemetry workflow 500 for forming and publishing a telemetry scheme.

### DETAILED DESCRIPTION

Disclosed herein are systems and methods for enhancing downhole measurements at the surface by increasing resolution with a limited telemetry bandwidth. Herein, this disclosure may comprise systems and methods for efficiently using a limited telemetry bandwidth by tuning the resolution of downhole measurements to expected values. Expected values may comprise a frequency table calculated from existing infield memory data. A real-time telemetry table for transmission lookup may be provided based at least on the expected values. A pseudo log may be formed based on the real-time telemetry table and compared to a memory curve. Form areas of data clustering based on the comparison and mark desired resolution increase in critical areas and desired resolution decrease in non-critical areas. Rebuild the telemetry table and publish telemetry table and implement telemetry table and utilize for telemetry while drilling.

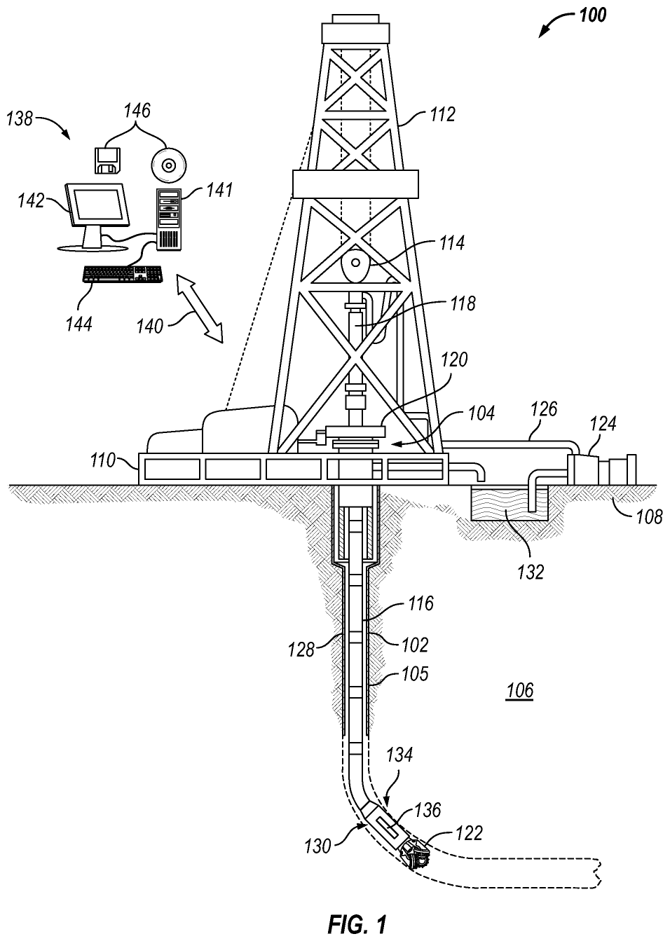

FIG. 1 illustrates a schematic diagram of a drilling system 100 for implementing a downhole tool with logging while drilling (LWD) techniques. Generally, the downhole tool could be any tool that may experience vibrations because of its operation downhole. Vibration in this context comprise any cyclical, repetitive motion in any of one or more axes of freedom. The downhole tool in this example comprises a rotary steerable tool (RSS) 130 used in a bottom hole assembly (BHA) 134 to provide directional control while drilling a wellbore 102 from the surface 108 of the well site down into a subterranean formation 106. For example, the RSS 130 may be a “push the bit” type system that uses coordinated movement of pad pushers against the wellbore 102 to urge a drill bit 122 in a particular direction. Alternatively, the RSS 130 may be a “point the bit” type system that can adjust the orientation of a drill bit axis relative a body of the RSS 130 to point the drill bit 122 in the desired direction. Directional drilling may result in any number of horizontal, vertical, slanted, curved, and other types of wellbore geometries and orientations to achieve a desired wellbore path. After drilling the wellbore 102, portions of the wellbore 102 may be lined with a tubular, metallic structure referred to as a casing 105. Although certain drawing features of FIG. 1 depict a land-based oil and gas rig, it will be appreciated that the embodiments of the present disclosure are useful with other types of rigs, such as offshore platforms or floating rigs used for subsea wells, and in any other geographical location. For example, in a subsea context, the surface may represent the floor of a seabed, and the rig floor may represent an offshore platform or floating rig over the water above the seabed.

The well site includes a drilling platform 110 with a support structure such as a derrick 112 erected over a wellhead 104 at the surface 108 of the well site. Derrick 112 or other support structure may include equipment for raising and lowering the drill string 116 and other tool strings using in constructing, operating, and maintaining the well. This equipment may include a traveling block 114 used for raising and lowering the drill string 116 while drilling and a kelly 118 to support the drill string 116 as it is lowered through a rotary table 120. The drill string 116 comprises the BHA 134 (which includes the RSS 130) and a tubular conveyance extending from the surface 108 down into the wellbore 104. The tubular conveyance supports the weight of the BHA 134 for raising and lowering into the well and provides fluid and/or electrical communication between the tools and surface 108. In this example the tubular conveyance comprises a long string of drill pipe segments that may be progressively added at the surface 108 throughout drilling operations in order to reach a desired depth. A pump 124 may circulate drilling fluid (i.e., mud) from a retention pit 132, through a feed pipe 126, downhole through the drill string 116, out through nozzles in a drill bit 122, and back to the surface 108 via an annulus 128 surrounding drill string 116. Rotation of drill bit 122 may be driven by rotation of the entire drill string 116 from surface 108 and/or by rotation of a downhole motor.

Drilling, particularly when using an RSS 130, introduces complex dynamics into drill string 116. Even in a relatively simple scenario of drilling a straight wellbore section, a downhole force is applied axially during drilling, referred to as weight on bit (WOB), while a drill bit is simultaneously rotated at certain revolutions per minute (RPM) to cut the formation. Torque may be applied to the drill string in the desired rotational direction while the drill bit and portions of the drill string encounter competing frictional forces against the wellbore 102. Unpredictable or sporadic torsional behavior may result from this interaction, such as stick-slip. The drill string 116 is constrained to follow the deviated wellbore path drilled using the RSS 130, which introduces further uncertainty into the dynamic behavior of the drill string 116. The RSS 130 itself introduces further complexity. For example, in a push-the-bit system, pad pushers are forcefully engaging the wellbore 102 to urge the drill bit 122 in a lateral direction. The movement of the pad pushers is precisely coordinated to bias in a particular direction. The RSS 130 in some systems may also have a counter-rotating housing to remain geostationary while drilling. It can be appreciated that this combination of forces and dynamics while drilling cannot always be fully described with a conventional physics model.

An aspect of this disclosure is the identification of a relationship between vibrations in drill string 102 and the performance and longevity of well tools. Vibrations in the RSS 130 may result from one or more different vibration mechanism (VM), optionally in addition to other mechanism(s). A vibration mechanism according to this disclosure may directly relate to a specific or discrete vibration source or combination of vibration sources. For example, vibration mechanisms may include oscillating motions in any axis of freedom, including but not limited to individual torsional, axial, or lateral vibration components identifiable from sensor data. The vibration mechanisms may also include certain vibrational patterns or phenomenon resulting from the complex dynamics of drilling and which may have multiple contributing factors. As a non-limiting example, such other vibration mechanisms may include so-called stick-slip, which is generally a cyclical pattern whereby a portion of the drill string is temporarily stuck until a drill string torque overcomes friction and the torsional energy is released. Moreover, a tool or a portion of tool typically has natural resonant frequencies. When operating close to those resonant frequencies, vibration damage could be much worse, as compared to other vibration frequencies that may be associated with regular wear and tear on a tool. Stick-slip motion, in particular, is an example of a sudden motion change in time domain, which creates wide frequency spectrum, but frequencies are on the low side. High frequency torsional vibration is another candidate for potential tool damage.

The RSS 130 and other components of the BHA 134 may comprise measurement assembly 136. Measurement assembly 136 may comprise one or more sensors with transmitters and/or receivers for collecting data of formation 106 and forming a downhole measurement log. The downhole measurement log may be formed with downhole measurements in real time. Herein, real time may be defined as 1 day to 1 hour, 1 hour to 1 minute, 1 minute to 1 second, 1 second to 1 ms, or 1 ms to 0.001 ms. The BHA 134, for example, may include a measurement-while drilling (MWD) system for gathering sensor data used to guide drilling and/or a logging-while-drilling (LWD) system to gather information about the formation being drilled. In examples, measurement assembly 136 may include any of a variety of dynamic sensors, including but not limited to one or more gyroscopes (i.e., gyros), accelerometers, magnetometers, speed sensors, position sensors, and vibration sensors. A gyroscopes, alternately referred to as a “gyro,” is a device that measures rotational motion. Gyros may be implemented, for example, as MEMS (microelectromechanical system) that measure angular velocity. The units of angular velocity are measured in degrees per second or revolutions per second (RPS). A magnetometer is a scientific instrument that measures the strength and/or direction of a magnetic field. Typically, magnetometers measure a magnetic field or flux density in metric units of gauss (G) or the international system (IS) unit tesla (T). An accelerometer is a sensor that measures acceleration, which is the change in speed (velocity) per unit time. Measuring acceleration makes it possible to obtain information such as object inclination and vibration, force, torque etc. Magnetometers can tell tool inclination and rotating speed. Derivative of rotation speed from gyros and magnetometers can be used for angular acceleration, thus torque and force.

Measurement assembly 136 may also perform downhole measurements. Downhole measurements may comprise directional drilling, resistivity, density, calibration, gamma ray, pressure, vibration, downhole Weight on Bit (WOB)/torque on bit (TOB)/high frequency bending of the drill bit (BOB) data, and/or porosity measurements. Measurement assembly 136 may comprise any type and number of sensors, electrodes, transducers, manometers, and/or the like. In other examples, various dynamic sensors (e.g., gyroscope, accelerometer, and magnetometer) may be analyzed to identify vibrations.

An information handling system 138 in direct or indirect communication with measurement assembly 136 may be used to gather, store, process, communicate, and analyze the data from the sensors and other inputs.

In examples, information handling system 138 may comprise various spatially separated components, which may comprise various above-ground components (e.g., at a surface of the well site and/or a remote location) and/or below-ground components. Such distributed or spatially separated components may be connected over a network or other suitable electronic communication medium. Thus, processing, storing, and/or analyzing of information may occur at different locations and times, and may occur partially downhole, partially at the surface of the well site, and/or partially at a remote location, such as another well site or a remote data processing center. Sensor data and other information processed downhole may be transmitted to surface to be recorded, observed, and/or further analyzed at the surface or remote site. Additionally, information recorded on information handling system 138 that may be disposed downhole may be stored until RSS 130 may be brought to surface 108. In some examples, the information handling system 138 may communicate with the RSS 130 through a telemetry system (e.g., mud pulse, magnetic, acoustic, wired pipe, or combinations thereof) in real-time mode. Information handling system 138 may transmit information to the RSS 130 or BHA 134 and may receive as well as process information recorded by RSS 130 or BHA 134.

Regardless of the orientation of information handling system 138, downhole measurements from measurement assembly 138 must be transmitted to surface 108. Any suitable technique may be used for transmitting downhole measurements from measurement assembly 138 to surface 108, including, but not limited to, wired pipe telemetry, mud-pulse telemetry, acoustic telemetry, and electromagnetic telemetry. While not illustrated, BHA 130 may include a telemetry subassembly that may transmit telemetry data to information handling system 138. At information handling system 138, pressure transducers (not shown) may convert the pressure signal into electrical signals for a digitizer (not illustrated). The digitizer may supply a digital form of the telemetry signals to information handling system 138 via a communication link 140, which may be a wired or wireless link. The telemetry data may be analyzed and processed by information handling system 138. Telemetry may be performed by a surface computer that converts the digital signal into name value pairs for input to a processing algorithm.

As illustrated, communication link 140 (which may be wired or wireless, for example) may be provided that may transmit data from BHA 130 to an information handling system 138 at information handling system 138. Information handling system 138 may include a personal computer 141, a video display 142, a keyboard 144 (i.e., other input devices), and/or non-transitory computer-readable media 146 (e.g., optical disks, magnetic disks) that can store code representative of the methods described herein. In addition to, or in place of processing at surface 108, processing may occur downhole.

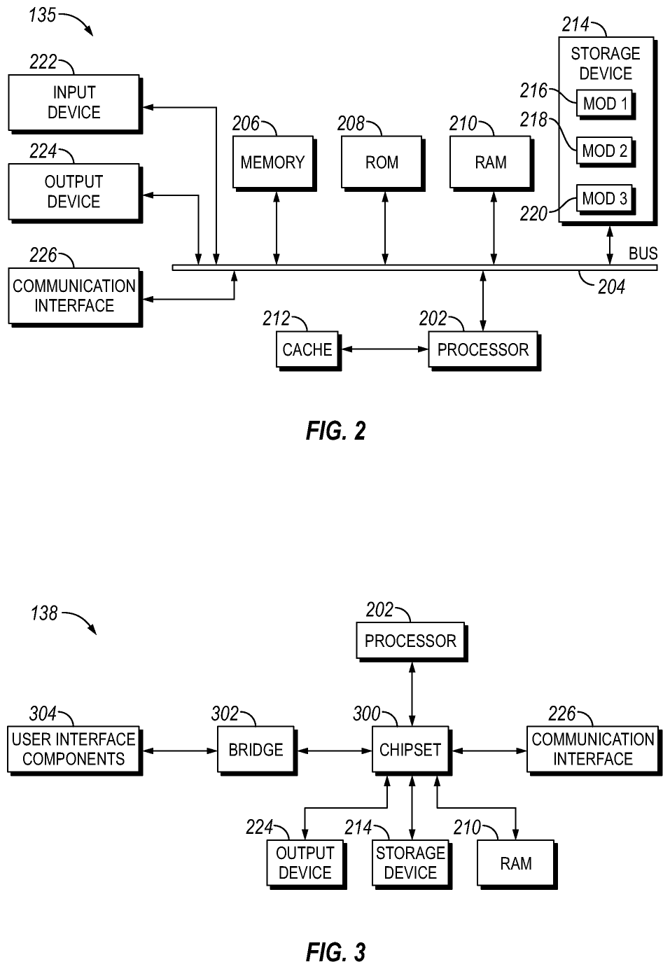

FIG. 2 illustrates an example information handling system 138 which may be employed to perform various steps, methods, and techniques disclosed herein. Persons of ordinary skill in the art will readily appreciate that other system examples are possible. As illustrated, information handling system 138 includes a processing unit (CPU or processor) 202 and a system bus 204 that couples various system components including system memory 206 such as read only memory (ROM) 208 and random-access memory (RAM) 210 to processor 202. Processors disclosed herein may all be forms of this processor 202. Information handling system 138 may include a cache 212 of high-speed memory connected directly with, in close proximity to, or integrated as part of processor 202. Information handling system 138 copies data from memory 206 and/or storage device 214 to cache 212 for quick access by processor 202. In this way, cache 212 provides a performance boost that avoids processor 202 delays while waiting for data. These and other modules may control or be configured to control processor 202 to perform various operations or actions. Another system memory 206 may be available for use as well. Memory 206 may include multiple different types of memory with different performance characteristics. It may be appreciated that the disclosure may operate on information handling system 138 with more than one processor 202 or on a group or cluster of computing devices networked together to provide greater processing capability. Processor 202 may include any general-purpose processor and a hardware module or software module, such as first module 216, second module 218, and third module 220 stored in storage device 214, configured to control processor 202 as well as a special-purpose processor where software instructions are incorporated into processor 202.

Processor 202 may be a self-contained computing system, containing multiple cores or processors, a bus, memory controller, cache, etc. A multi-core processor may be symmetric or asymmetric. Processor 202 may include multiple processors, such as a system having multiple, physically separate processors in different sockets, or a system having multiple processor cores on a single physical chip. Similarly, processor 202 may include multiple distributed processors located in multiple separate computing devices but working together such as via a communications network. Multiple processors or processor cores may share resources such as memory 206 or cache 212 or may operate using independent resources. Processor 202 may include one or more state machines, an application specific integrated circuit (ASIC), or a programmable gate array (PGA) including a field PGA (FPGA).

Each individual component discussed above may be coupled to system bus 204, which may connect each and every individual component to each other. System bus 204 may be any of several types of bus structures including a memory bus or memory controller, a peripheral bus, and a local bus using any of a variety of bus architectures. A basic input/output (BIOS) stored in ROM 208 or the like, may provide the basic routine that helps to transfer information between elements within information handling system 138, such as during start-up. Information handling system 138 further includes storage devices 214 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. Storage device 214 may include software modules 216, 218, and 220 for controlling processor 202. Information handling system 138 may include other hardware or software modules. Storage device 214 is connected to the system bus 204 by a drive interface. The drives and the associated computer-readable storage devices provide nonvolatile storage of computer-readable instructions, data structures, program modules and other data for information handling system 138. In one aspect, a hardware module that performs a particular function includes the software component stored in a tangible computer-readable storage device in connection with the necessary hardware components, such as processor 202, system bus 204, and so forth, to carry out a particular function. In another aspect, the system may use a processor and computer-readable storage device to store instructions which, when executed by the processor, cause the processor to perform operations, a method or other specific actions. The basic components and appropriate variations may be modified depending on the type of device, such as whether information handling system 138 is a small, handheld computing device, a desktop computer, or a computer server. When processor 202 executes instructions to perform “operations”, processor 202 may perform the operations directly and/or facilitate, direct, or cooperate with another device or component to perform the operations.

As illustrated, information handling system 138 employs storage device 214, which may be a hard disk or other types of computer-readable storage devices which may store data that are accessible by a computer, such as magnetic cassettes, flash memory cards, digital versatile disks (DVDs), cartridges, random access memories (RAMs) 210, read only memory (ROM) 208, a cable containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with information handling system 138, an input device 222 represents any number of input mechanisms, such as a microphone for speech, a touch-sensitive screen for gesture or graphical input, keyboard, mouse, motion input, speech and so forth. Additionally, input device 222 may take in data from measurement assembly 136, discussed above. An output device 224 may also be one or more of a number of output mechanisms known to those of skill in the art. In some instances, multimodal systems enable a user to provide multiple types of input to communicate with information handling system 138. Communications interface 226 generally governs and manages the user input and system output. There is no restriction on operating on any particular hardware arrangement and therefore the basic hardware depicted may easily be substituted for improved hardware or firmware arrangements as they are developed.

As illustrated, each individual component described above is depicted and disclosed as individual functional blocks. The functions these blocks represent may be provided through the use of either shared or dedicated hardware, including, but not limited to, hardware capable of executing software and hardware, such as a processor 202, that is purpose-built to operate as an equivalent to software executing on a general-purpose processor. For example, the functions of one or more processors presented in FIG. 2 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 308 for storing software performing the operations described below, and random-access memory (RAM) 310 for storing results. Very large-scale integration (VLSI) hardware embodiments, as well as custom VLSI circuitry in combination with a general-purpose DSP circuit, may also be provided.

The logical operations of the various methods, described below, are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. Information handling system 138 may practice all or part of the recited methods, may be a part of the recited systems, and/or may operate according to instructions in the recited tangible computer-readable storage devices. Such logical operations may be implemented as modules configured to control processor 202 to perform particular functions according to the programming of software modules 216, 218, and 220.

In examples, one or more parts of the example information handling system 138, up to and including the entire information handling system 138, may be virtualized. For example, a virtual processor may be a software object that executes according to a particular instruction set, even when a physical processor of the same type as the virtual processor is unavailable. A virtualization layer or a virtual “host” may enable virtualized components of one or more different computing devices or device types by translating virtualized operations to actual operations. Ultimately however, virtualized hardware of every type is implemented or executed by some underlying physical hardware. Thus, a virtualization computer layer may operate on top of a physical computer layer. The virtualization computer layer may include one or more virtual machines, an overlay network, a hypervisor, virtual switching, and any other virtualization application.

FIG. 3 illustrates an example information handling system 138 having a chipset architecture that may be used in executing the described method and generating and displaying a graphical user interface (GUI). Information handling system 138 is an example of computer hardware, software, and firmware that may be used to implement the disclosed technology. Information handling system 138 may include a processor 202, representative of any number of physically and/or logically distinct resources capable of executing software, firmware, and hardware configured to perform identified computations. Processor 202 may communicate with a chipset 300 that may control input to and output from processor 202. In this example, chipset 300 outputs information to output device 224, such as a display, and may read and write information to storage device 214, which may include, for example, magnetic media, and solid-state media. Chipset 300 may also read data from and write data to RAM 210. Bridge 302 for interfacing with a variety of user interface components 304 may be provided for interfacing with chipset 300. User interface components 304 may include a keyboard, a microphone, touch detection and processing circuitry, a pointing device, such as a mouse, and so on. In general, inputs to information handling system 138 may come from any of a variety of sources, machine generated and/or human generated.

Chipset 300 may also interface with one or more communication interfaces 226 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 202 analyzing data stored in storage device 214 or RAM 210. Further, information handling system 138 receives inputs from a user via user interface components 304 and executes appropriate functions, such as browsing functions by interpreting these inputs using processor 202.

In examples, information handling system 138 may also include tangible and/or non-transitory computer-readable storage devices for carrying or having computer-executable instructions or data structures stored thereon. Such tangible computer-readable storage devices may be any available device that may be accessed by a general purpose or special purpose computer, including the functional design of any special purpose processor as described above. By way of example, and not limitation, such tangible computer-readable devices may include RAM, ROM, EEPROM, CD-ROM or other optical disk storage, magnetic disk storage or other magnetic storage devices, or any other device which may be used to carry or store desired program code in the form of computer-executable instructions, data structures, or processor chip design. When information or instructions are provided via a network, or another communications connection (either hardwired, wireless, or combination thereof), to a computer, the computer properly views the connection as a computer-readable medium. Thus, any such connection is properly termed a computer-readable medium. Combinations of the above should also be included within the scope of the computer-readable storage devices.

In examples, information handling system 138 may also include tangible and/or non-transitory computer-readable storage devices for carrying or having computer-executable instructions or data structures stored thereon. The non-transitory computer readable media 148 may store software or instructions of the methods described herein. Non-transitory computer readable media 148 may include any instrumentality or aggregation of instrumentalities that may retain data and/or instructions for a period of time. Non-transitory computer readable media 148 may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing.

Such tangible computer-readable storage devices may be any available device that may be accessed by a general purpose or special purpose computer, including the functional design of any special purpose processor as described above. By way of example, and not limitation, such tangible computer-readable devices may include RAM, ROM, EEPROM, CD-ROM or other optical disk storage, magnetic disk storage or other magnetic storage devices, or any other device which may be used to carry or store desired program code in the form of computer-executable instructions, data structures, or processor chip design. When information or instructions are provided via a network, or another communications connection (either hardwired, wireless, or combination thereof), to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

In additional examples, methods may be practiced in network computing environments with many types of computer system configurations, including personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

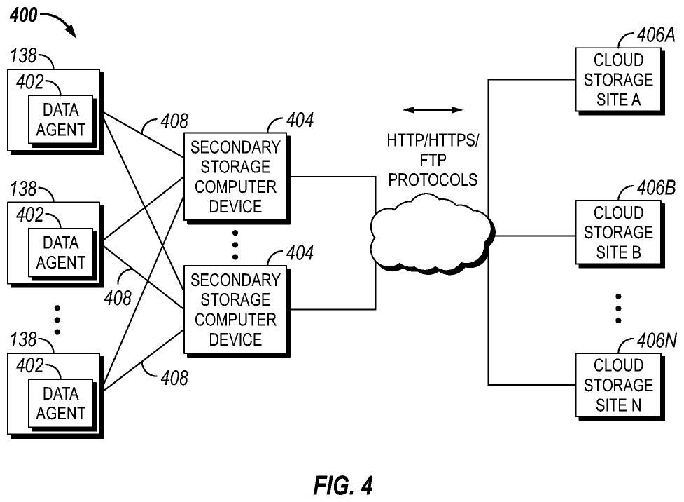

FIG. 4 illustrates an example of one arrangement of resources in a computing network 400 that may employ the processes and techniques described herein, although many others are of course possible. As noted above, an information handling system 138, as part of their function, may utilize data, which includes files, directories, metadata (e.g., access control list (ACLS) creation/edit dates associated with the data, etc.), and other data objects. The data on the information handling system 138 is typically a primary copy (e.g., a production copy). During a copy, backup, archive or other storage operation, information handling system 138 may send a copy of some data objects (or some components thereof) to a secondary storage computing device 404 by utilizing one or more data agents 402.

A data agent 402 may be a desktop application, website application, or any software-based application that is run on information handling system 138. As illustrated, information handling system 138 may be disposed at any rig site (e.g., referring to FIG. 1) or repair and manufacturing center. Data agent 402 may communicate with a secondary storage computing device 404 using communication protocol 408 in a wired or wireless system. Communication protocol 408 may function and operate as an input to a website application. In the website application, field data related to pre- and post-operations, generated DTCs, notes, and the like may be uploaded. Additionally, information handling system 138 may utilize communication protocol 408 to access processed measurements, operations with similar DTCs, troubleshooting findings, historical run data, and/or the like. This information is accessed from secondary storage computing device 404 by data agent 402, which is loaded on information handling system 138.

Secondary storage computing device 404 may operate and function to create secondary copies of primary data objects (or some components thereof) in various cloud storage sites 406A-N. Additionally, secondary storage computing device 404 may run determinative algorithms on data uploaded from one or more information handling systems 138, discussed further below. Communications between the secondary storage computing devices 404 and cloud storage sites 406A-N may utilize REST protocols (Representational state transfer interfaces) that satisfy basic C/R/U/D semantics (Create/Read/Update/Delete semantics), or other hypertext transfer protocol (“HTTP”)-based or file-transfer protocol (“FTP”)-based protocols (e.g., Simple Object Access Protocol).

In conjunction with creating secondary copies in cloud storage sites 406A-N, the secondary storage computing device 404 may also perform local content indexing and/or local object-level, sub-object-level or block-level deduplication when performing storage operations involving various cloud storage sites 406A-N. Cloud storage sites 406A-N may further record and maintain DTC code logs for each downhole operation or run, map DTC codes, store repair and maintenance data, store operational data, and/or provide outputs from determinative algorithms that are run at cloud storage sites 406A-N. In examples, computing network 400 may be communicatively coupled to measurement assembly 136 (e.g., referring to FIG. 1). As previously described, information handling system 138 may be operable via telemetry techniques to receive downhole measurements at surface 108.

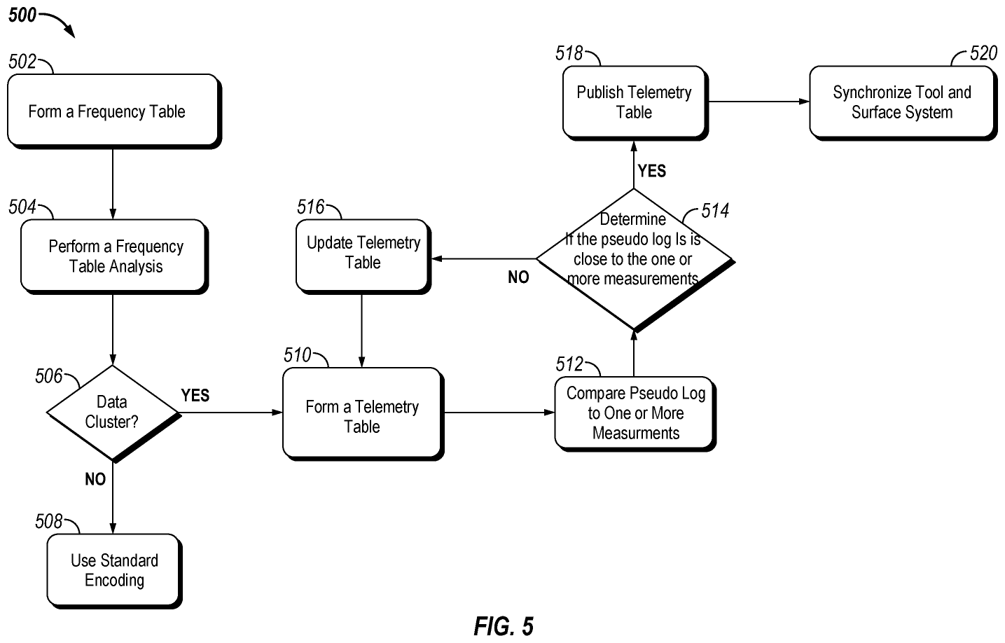

FIG. 5 illustrates telemetry workflow 500 for forming and publishing a telemetry scheme. In examples, telemetry workflow 500 may be performed on information handling system 138 (e.g., referring to FIG. 1). In block 502, a frequency table of expected values may be formed for one or more measurements acquired with measurement assembly 136. In examples, one or more measurements may be acquired by measurement assembly 136 in real time. In other examples, information handling system 138 may import previous drilling log data. Previous drilling log data and/or one or more measurements acquired with measurement assembly 136 may comprise one or more specific depths for oil and gas. Herein one or more specific depths for oil and gas may be defined as “pay zones” comprising hydrocarbon zones (oil or gas). Additionally, one or more specific depths for oil and gas may comprise one or more formation markers. A formation marker may provide valuable information to orient BHA 134 to other downhole objectives. For example, BHA 134 may experience trouble drilling in formations with high pressure. Trouble in high pressure formation may amount to failure and/or damage to BHA 134. Therefore, formation markers identifying such formations allow BHA 134 to avoid or take precautions in such formations. Further, one or more specific depths for oil and gas may comprise mineral properties.

Information handling system may build a frequency table histogram with one or more specific depths for oil and gas. In block 504 a frequency table analysis of the frequency table histogram from block 502 may be performed. The analysis may comprise weighting areas of high counts and de-weighting areas of low counts. In examples, the analysis may sum the total number of counts for every distinct value. A score for every distinct value may be assigned by dividing the number of counts for each distinct value by the sum of the total number of counts for every distinct value. As such, the analysis may provide a score for each unique distinct value. Further, each unique value may be defined within a dynamic range.

In block 506, data clusters for high scores for each unique distinct value may be discovered. In examples, data clustering may be performed by standard techniques to group data into clusters. As such, data clustering may organize data such that points closer in magnitude may be clustered together into one cluster. Effectively, different clusters may be formed comprising data of similar magnitude. In examples, data clustering may or may not form clusters depending on the data. To determine if there is sufficient data clustering a standard deviation test may be applied. Herein, a standard deviation test may determine there was sufficient data clustering if the spike or average magnitude of the cluster is more than one standard deviation away from at least one of its neighboring cluster's spike or average magnitude of the cluster. In block 508, if there is not sufficient data clustering, standard telemetry may be applied.

In block 510 a telemetry table may be formed with one or more operating depths based at least on one or more specific depths for oil and gas. A telemetry table may convert a telemetry value to a scientific value. In examples, if a telemetry value may be an 8-bit number, there may be 256 possible telemetry values to be transmitted. Each possible telemetry value may be mapped to an appropriate scientific value in the telemetry table. For example, if the telemetry table comprises 256 possible telemetry values, they may be converted to scientific values linearly from 0.01 ohms to 2000 ohms. The telemetry table may be utilized to convert downhole measurements from scientific values to possible telemetry values. The possible telemetry values may be transmitted to surface 108, as described above. At surface 108 possible telemetry values may be converted from possible telemetry values to scientific values to form a pseudo log. In addition, rather than being transmitted to the surface, telemetry values may be converted back to scientific values with the telemetry table downhole.

In examples, even within one or more operating depths, the telemetry table may not perfectly convert scientific values to telemetry values and back to scientific values for every measurement from the one or more measurements (i.e., from one or more measurements to a pseudo log) perfectly. The goal of the telemetry table is to broaden the limited telemetry bandwidth to one or more specific depths for oil and gas. As such, depths within one or more specific depths for oil and gas may have a larger bandwidth and a clearer distinction between different points. Therefore, the telemetry table may assign more bits in a telemetry value to one or more operating depths. In contrast, depths outside of one or more one or more operating depths may have less bandwidth and broader or more gray representations in the pseudo log. In effect, a larger bandwidth means the telemetry table may assign larger portions of a telemetry value to one or more specific depths for oil and gas. Therefore, such depths outside one or more operating depths may have less bits assigned in the telemetry value. Additionally, the telemetry table may be updated if it does not encompass an adjustable threshold of one or more specific depths for oil and gas, to be discussed below. Further, the pseudo log and telemetry table may be acquired and formed in real time.

In examples, forming a telemetry table may comprise identifying one or more operating depths based at least on one or more specific depths for oil and gas. Identifying one or more depths may comprise simplifying one or more specific depths for oil and gas. As such, the operating depths may only comprise a few selected depths from the one or more specific depths. The one or more operating depths may be adjacent within the same region and/or adjacent outside of a similar region. Additionally, a user may have the option to select a field comprising specific minerals or hydrocarbons and limit one or more specific depths for oil and gas to previous measurements within the field.

As previously described, measurement assembly 136 (e.g., referring to FIG. 1) may comprise sensors and/or transmitters to form a downhole measurement log. In examples, the downhole measurement log may be formed in real time. In block 512, a pseudo log from block 510 may be compared to one or more measurements acquired by measurement assembly 136. The comparison may determine the difference for at least every depth of one or more specific depths for oil and gas. The difference at each depth may be calculated as percent difference in equation (1).

$$percent difference = \frac{\vert pseudo log value - measurment value \vert}{\frac{pseudo log value + m e a s u rment value}{2}} * 100 \% \qquad ( 1 )$$

Herein, pseudo log value is a representative value of the pseudo log at the depth and measurement log value is a representative measurement of one measurement from the one or more measurements at the depth.

In other examples, a user may perform a comparison between the pseudo log and the one or more measurements by any standard technique. In block 514, it may be determined if the pseudo log is close to the one or more measurements acquired by BHA 134 (e.g., referring to FIG. 1) as discussed above. Determining may comprise a user's input to determine if the theoretical telemetry pulse comprises a sufficient resolution for all one or more specific depths for oil and gas. A user's input may be a visual analysis comparing the pseudo log directly to the one or more measurements acquired by BHA. Further, the user's input may determine the pseudo log and the one or more measurements are not within a user's threshold. Herein, a user's threshold may be defined by the user for the specific oil and gas operation.

In other examples, determining if the pseudo log is close to the one or more measurements may comprise assigning the adjustable threshold. After assigning the adjustable threshold, it may be determined that the pseudo log is close to the one or more measurements in the pseudo log if the calculated percent difference is less than the adjustable threshold for one or more depths.

Otherwise, if there is not sufficient resolution for all or one or more specific depths for oil and gas workflow 500 may proceed to block 516. In addition, it may be determined that there is not sufficient resolution if one or more depths of the one or more specific depths for oil and gas have a difference, from block 514 less than an adjustable threshold. In examples the adjustable threshold may be assigned between a range from 75%-50%, 50%-10%, 10%-1%, or 1%-.01%. If the difference is greater than the adjustable threshold then the telemetry table may be updated, as described below.

In block 516, the telemetry table from block 510 may be updated. Updating the telemetry table may comprise increasing the bandwidth for one or more operating depths without sufficient resolution. In examples, increasing said bandwidth may require decreasing bandwidths for one or more specific depths for oil and gas without sufficient resolution and/or decreasing or eliminating bandwidth for depths outside of one or more specific depths for oil and gas. Blocks 512, 514, and 516 may be iterated a plurality of times, each iteration with a new telemetry table.

If there is a sufficient resolution at every specific depth for oil and gas in the plot of block 510 or block 512 when for the case of a plurality of iterations, telemetry workflow 500 may proceed to block 518. In block 518, the telemetry table from block 510 or 516 may be published. Publishing the telemetry table may comprise assigning the telemetry table as a proper scheme for the field and assigned to memory data from block 502. In block 520 synchronizing tool and subsurface system may be performed. In examples the telemetry table from block 510 or 516 may be assigned to telemetry equipment downhole. The telemetry equipment downhole may comprise electronics primarily for implementing the telemetry coding technique to convert one or more measurements, acquired by BHA 134 (scientific values) into a telemetry signal (telemetry values). The telemetry equipment at the surface may comprise electronics for implementing decoding techniques to convert a telemetry signal (telemetry values) one or more measurements (scientific values).

The methods and systems described above are an improvement over current technology in that does not focus on specific areas of interest to generate a telemetry table that provides better information in critical areas. Telemetry tables are commonly built simply (scale and offset) or sometimes built to serve a wide variety of conditions and fields. This improvement allows a competent user to tune the information quality of the real-time data to the areas he/she is most interested in.

The systems and methods for using a distributed acoustic system in a subsea environment may include any of the various features of the systems and methods disclosed herein, including one or more of the following statements. Additionally, the systems and methods for an acoustic tool in a downhole environment may include any of the various features of the systems and methods disclosed herein, including one or more of the following statements.

Statement 1. A method comprising disposing a bottom hole assembly (BHA) into a wellbore, wherein the BHA comprises a measurement assembly configured to record one or more measurements; identifying one or more operating depths; forming a telemetry table based at least on one or more operating depths; acquiring a pseudo log by converting one or more measurements into telemetry values with the telemetry table and back to scientific values with the telemetry table; comparing the pseudo log to the one or more measurements to form a comparison; and publishing the telemetry table based at least in part on the comparison.

Statement 2. The method of claim 1, wherein identifying one or more operating depths comprises simplifying one or more specific depths for oil and gas.

Statement 3. The method of claim 2, wherein one or more specific depths for oil and gas are imported from previous drilling log data.

Statement 4. The method of statements 2 or 3, wherein one or more specific depths for oil and gas comprises pay zones comprising hydrocarbon zones, formation markers, or mineral properties.

Statement 5. The methods of statements 2-5, wherein comparing the pseudo log to the one or more measurements calculates a percent difference between the pseudo log and the one or more measurements.

Statement 6. The method of claim 5, wherein the percent difference is calculated at every depth by:

$$percent difference = \frac{\vert pseudo log value - measurment value \vert}{\frac{pseudo log value + m e a s u rment value}{2}} * 100 \%$$

wherein, pseudo log value is a representative value of the pseudo log at the depth and measurement log value is a representative measurement of one measurement from the one or more measurements at the depth.

Statement 7. The method of statements 5 or 6, wherein comparing the pseudo log to the one or more measurements comprises an adjustable threshold.

Statement 8. The method of claim 7, further comprising assigning the adjustable threshold and publishing the telemetry table if the percent difference is less than the adjustable threshold for one or more depths.

Statement 9. The method of claim 8, further comprising updating the telemetry table if the percent difference is more than the adjustable threshold for one or more depths.

Statement 10. The method of claim 9, wherein updating the telemetry table comprises increasing a bandwidth in the telemetry table for one or more operating depths where the percent difference is less than the adjustable threshold.

Statement 11. The method of claim 10, further comprising decreasing bandwidths for one or more depths outside of one or more operating depths.

Statement 12. The method of claims 1-11, further comprising updating the telemetry table if a user's input does not indicate the pseudo log and the one or more measurements are within a user's threshold.

Statement 13. A non-transitory storage computer-readable medium storing one or more instructions that, when executed by a processor, cause the processor to: identify one or more operating depths from one or more measurements acquired by a bottom hole assembly (BHA); form a telemetry table based at least on one or more operating depths; acquire a pseudo log by converting one or more measurements into telemetry values with the telemetry table and back to scientific values with the telemetry table; compare the pseudo log to the one or more measurements to form a comparison; and publish the telemetry table based at least in part on the comparison.

Statement 14. The non-transitory storage computer-readable medium of claim 13, wherein comparing the pseudo log to the one or more measurements calculates a percent difference between the pseudo log and the one or more measurements.

Statement 15. The non-transitory storage computer-readable medium of claim 14, wherein the percent difference is calculated at every depth by:

$$percent difference = \frac{\vert pseudo log value - measurment value \vert}{\frac{pseudo log value + m e a s u rment value}{2}} * 100 \%$$

wherein, pseudo log value is a representative value of the pseudo log at the depth and measurement log value is a representative measurement of one measurement from the one or more measurements at the depth.

Statement 16. The non-transitory storage computer-readable medium of claim 15, wherein the one or more instructions, that when executed by the processor, further cause the processor to compare the pseudo log to the one or more measurements comprises an adjustable threshold.

Statement 17. The non-transitory storage computer-readable medium of claim 16, wherein the one or more instructions, that when executed by the processor, further cause the processor to assign the adjustable threshold and publishing the telemetry table if the percent difference is less than the adjustable threshold for one or more depths.

Statement 18. The non-transitory storage computer-readable medium of claim 17, wherein the one or more instructions, that when executed by the processor, further cause the processor to update the telemetry table if the percent difference is more than the adjustable threshold for one or more depths.

Statement 19. The non-transitory storage computer-readable medium of claims 17 or 18, wherein updating the telemetry table comprises increasing a bandwidth in the telemetry table for one or more operating depths where the percent difference is less than the adjustable threshold and decreasing bandwidths for one or more depths outside of one or more operating depths.

Statement 20. The non-transitory storage computer-readable medium of claim 13, wherein the one or more instructions, that when executed by the processor, further cause the processor to update the telemetry table if a user's input does not indicate the pseudo log and the one or more measurements are within a user's threshold.

The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods may also “consist essentially of” or “consist of” the various components and steps. Moreover, the indefinite articles “a” or “an,” as used in the claims, are defined herein to mean one or more than one of the elements that it introduces.

For the sake of brevity, only certain ranges are explicitly disclosed herein. However, ranges from any lower limit may be combined with any upper limit to recite a range not explicitly recited, as well as ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only, and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A method comprising:
disposing a bottom hole assembly (BHA) into a wellbore, wherein the BHA comprises a measurement assembly configured to record one or more measurements;
identifying one or more operating depths;
forming a telemetry table based at least on one or more operating depths;
acquiring a pseudo log by converting one or more measurements into telemetry values with the telemetry table and back to scientific values with the telemetry table;
comparing the pseudo log to the one or more measurements to form a comparison; and
publishing the telemetry table based at least in part on the comparison.

2. The method of claim 1, wherein identifying one or more operating depths comprises simplifying one or more specific depths for oil and gas.

3. The method of claim 2, wherein one or more specific depths for oil and gas are imported from previous drilling log data.

4. The method of claim 2, wherein one or more specific depths for oil and gas comprises pay zones comprising hydrocarbon zones, formation markers, or mineral properties.

5. The method of claim 1, wherein comparing the pseudo log to the one or more measurements calculates a percent difference between the pseudo log and the one or more measurements.

6. The method of claim 5, wherein the percent difference is calculated at every depth by:
$$percent difference = \frac{\vert pseudo log value - measurment value \vert}{\frac{pseudo log value + m e a s u rment value}{2}} * 100 \%$$
wherein, pseudo log value is a representative value of the pseudo log at the depth and measurement log value is a representative measurement of one measurement from the one or more measurements at the depth.

7. The method of claim 5, wherein comparing the pseudo log to the one or more measurements comprises an adjustable threshold.

8. The method of claim 7, further comprising assigning the adjustable threshold and publishing the telemetry table if the percent difference is less than the adjustable threshold for one or more depths.

9. The method of claim 8, further comprising updating the telemetry table if the percent difference is more than the adjustable threshold for one or more depths.

10. The method of claim 9, wherein updating the telemetry table comprises increasing a bandwidth in the telemetry table for one or more operating depths where the percent difference is less than the adjustable threshold.

11. The method of claim 10, further comprising decreasing bandwidths for one or more depths outside of one or more operating depths.

12. The method of claim 1, further comprising updating the telemetry table if a user's input does not indicate the pseudo log and the one or more measurements are within a user's threshold.

13. A non-transitory storage computer-readable medium storing one or more instructions that, when executed by a processor, cause the processor to:
identify one or more operating depths from one or more measurements acquired by a bottom hole assembly (BHA);
form a telemetry table based at least on one or more operating depths;
acquire a pseudo log by converting one or more measurements into telemetry values with the telemetry table and back to scientific values with the telemetry table;
compare the pseudo log to the one or more measurements to form a comparison; and
publish the telemetry table based at least in part on the comparison.

14. The non-transitory storage computer-readable medium of claim 13, wherein comparing the pseudo log to the one or more measurements calculates a percent difference between the pseudo log and the one or more measurements.

15. The non-transitory storage computer-readable medium of claim 14, wherein the percent difference is calculated at every depth by:
$$percent difference = \frac{\vert pseudo log value - measurment value \vert}{\frac{pseudo log value + m e a s u rment value}{2}} * 100 \%$$
wherein, pseudo log value is a representative value of the pseudo log at the depth and measurement log value is a representative measurement of one measurement from the one or more measurements at the depth.

16. The non-transitory storage computer-readable medium of claim 14, wherein the one or more instructions, that when executed by the processor, further cause the processor to compare the pseudo log to the one or more measurements comprises an adjustable threshold.

17. The non-transitory storage computer-readable medium of claim 16, wherein the one or more instructions, that when executed by the processor, further cause the processor to assign the adjustable threshold and publishing the telemetry table if the percent difference is less than the adjustable threshold for one or more depths.

18. The non-transitory storage computer-readable medium of claim 17, wherein the one or more instructions, that when executed by the processor, further cause the processor to update the telemetry table if the percent difference is more than the adjustable threshold for one or more depths.

19. The non-transitory storage computer-readable medium of claim 17, wherein updating the telemetry table comprises increasing a bandwidth in the telemetry table for one or more operating depths where the percent difference is less than the adjustable threshold and decreasing bandwidths for one or more depths outside of one or more operating depths.

20. The non-transitory storage computer-readable medium of claim 13, wherein the one or more instructions, that when executed by the processor, further cause the processor to update the telemetry table if a user's input does not indicate the pseudo log and the one or more measurements are within a user's threshold.
